(19) United States
(12) Patent Application Publication
(10) Pub. No.: US 2006/0056445 A1
(43) Pub. Date: Mar. 16, 2006

(54) Method for accessing a device with an IP address being modified spontaneously

(75) Inventor: Yung-Yi Lin, Hsin-chu (TW)

Correspondence Address: TROXELL LAW OFFICE PLLC, SUITE 1404, 5205 LEESBURG PIKE, FALLS CHURCH, VA, 22041, US

(73) Assignee: Z-COM, INC.

(21) Appl. No.: 11/171,332

(22) Filed: Jul. 1, 2005

(30) Foreign Application Priority Data
Sep. 10, 2004 (TW) 93127576

(51) Int. Cl. H04J 3/22

(52) U.S. Cl. 370/465

(57) ABSTRACT

A method for accessing a network device with an IP address being modified spontaneously is described. A resolution program installed in the network device resolves the request string in an HTTP packet, in which the configuration of the network device can be modified automatically according to the information of packet broadcast from a control end. Since the network device can spontaneously modify its own configuration learning from the network configuration broadcast, the control end can simply access the network device using the device's name corresponding to a modified IP address in the same domain without any manual configuration.

### BACKGROUND OF THE INVENTION

1. Field of the Invention

The present invention relates to a method for accessing a device with an IP address being modified spontaneously, and more particularly to a network device that can modify its own network configuration, learning from a control end in use during accessing.

2. Description of Related Art

Network-related devices, such as a router, switch, or access point device, need to be configured through the command mode in a remote host via a communication port. Since the embedded operation system is used generally, almost all network devices or future information appliances can be configured and accessed through the built-in HTTP server program. The remote host can do the configuration or any other setting through a web browser via a RJ-45 or wireless connection.

FIG. 1 is a schematic diagram of a remote configuration in the prior art. Network device AP1, which is, for example, a router, switch or IP sharing device, connects to a computer PC1. An embedded operation system is built in the network device AP1; the OS can be, for example, Linux, Cisco IOS, or Windows. Moreover, there is a HTTP server program built in the device. In general, a set of default IP address set exists originally on the network device, such as 192.168.0.1 shown in the figure, and the computer PC1 also needs a set of IP address as 192.168.0.2 as shown in FIG. 1. Both the IP addresses 192.168.0.1, 192.168.0.2 should be in the same local area network (LAN), and belong to one sub-network 192.168.0.0 with subnet mask 255.255.255.0. Finally, the computer PC1 can access the network device AP1 using a web browser via network connection.

In addition to the default IP address set on the network device, an automatic IP allocation software can be installed in the device. The software's purpose is to enable an individual host or device on an IP network to extract their configurations from a server, such as, for example, a DHCP (Dynamic Host Configuration Protocol) server or BOOTP (Bootstrap Protocol) server. When a computer PC1 at a control end connects to the network device AP1, in particular, the computer PC1 will request the network information of the device AP1, and the configuration of the computer PC1 should be modified according to the required IP address, subnet mask, DNS, and network gateway. After that, the computer PC1 can access the device AP1 in the same network condition.

Reference is made to FIG. 2, which is a schematic diagram of the network devices AP1, AP2, AP3 located in a local area network (LAN). These devices connect with each other and to a plurality of computers PC1, PC2 via a hub 10 or a switch. If the network device AP1 needs to be configured, the network configuration of the remote computer PC1 should be modified accordingly. Both distinct IP addresses should be in the same sub-network and the same subnet mask, or the computer PC1 extracts the required network configuration from the network device. Then the computer PC1 can access the network device AP1.

FIG. 3 illustrates the flow chart of the general process for accessing the network device. The process is described as follows. At first, the network devices and the computer at the control end are connected physically with each other. The network configuration of the computer at the control end should be modified according to the setting in the network device (step S300). The computer at the control end generates a HTTP request packet, and broadcasts the request packet to the network devices with known IP addresses (step S301). After the network devices receive the HTTP request packet, the devices respond to the request with, for example, an ACK (Acknowledgement character) packet and send the corresponding IP addresses (step S302). The computer links the network device-to-be-configured successfully according to the IP address, and, a three-way handshake, for example, is reached (step S303). The computer at the control end then starts to access the device-to-be-configured with a web page (step S304).

As mentioned above, the network device is configured via the web page generated in a HTTP server program. An ordinary computer can be used to access the device without installing any additional software, which is advantageous, but if the device exists in a complex network environment, it is hard to distinguish the specific device that needs to be configured. In fact, the network devices from the same factory will have the same network configuration, which doesn't fit with the present condition. Furthermore, the initial configuration of the network device needs to prevent IP addresses conflict, and needs to have the same network section or subnet mask, or extract a coincident configuration from the dynamic configuration.

### SUMMARY OF THE INVENTION

The present invention introduces a method for accessing a device with an IP address being modified spontaneously. A resolution program installed in the network device can resolve a request string in a HTTP packet. The network device with that program can recognize the network information in the HTTP packet broadcast from a control end, and spontaneously modify its own configuration. The control end can thus access the device using the device's name only. A preferable embodiment of this invention comprises the steps of generating a HTTP request packet from a control end, querying whether the name of device corresponds to a target IP address, broadcasting the HTTP packet, receiving the name recorded in the HTTP packet at the device end, spontaneously modifying the IP address at the device end, feeding back the IP address of the device to the control end and starting to access the device.

### BRIEF DESCRIPTION OF DRAWINGS

The present invention will be readily understood by the following detailed description in conjunction accompanying drawings, in which:

FIG. 1 is a schematic diagram of a remote configuration according to the prior art;

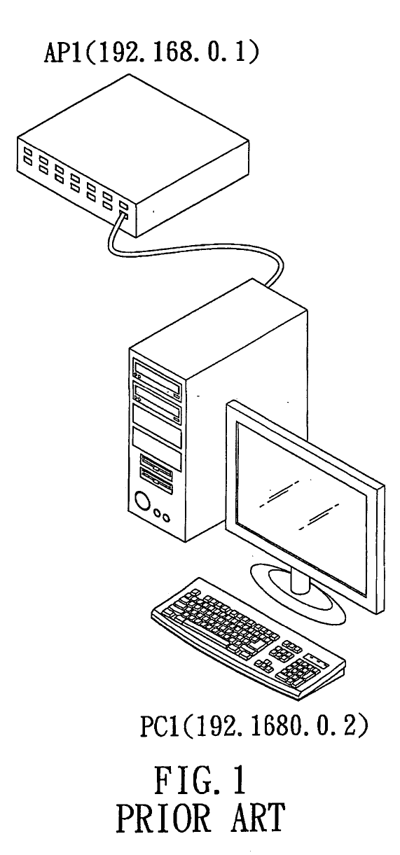

FIG. 2 is a schematic diagram of the network devices located in a local area network (LAN) according to the prior art;

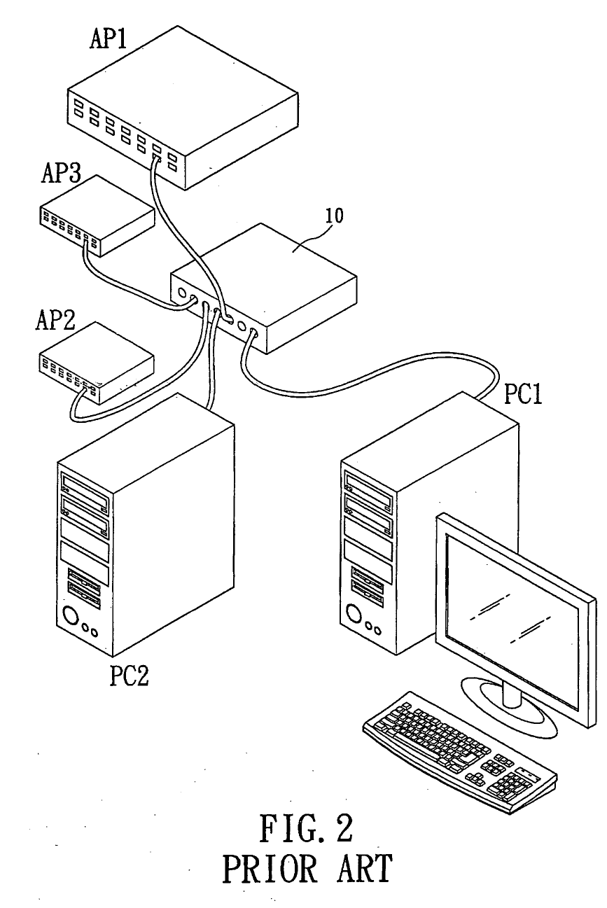

FIG. 3 illustrates the flow chart of the general process for accessing the network device of prior art; and

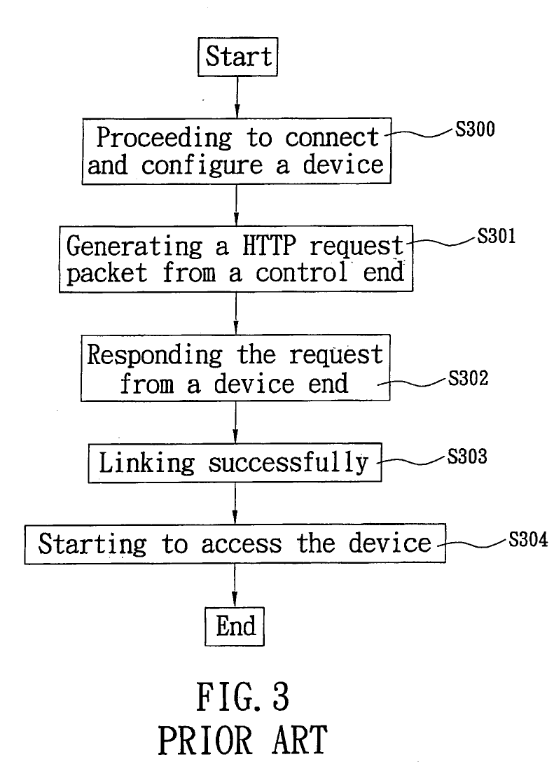

FIG. 4 is a flow chart of a preferable embodiment of the present invention.

### DETAILED DESCRIPTION OF THE PREFERRED EMBODIMENTS

To allow the Examiner to understand the technology, means and functions adopted in the present invention, reference is made to the following detailed description and attached drawing. The Examiner shall readily understand the invention deeply and concretely from the purpose, characteristics and specification of the present invention. Nevertheless, the present invention is not limited to the attached drawings and embodiments in following description.

Network devices, such as a router, switch, IP sharing device, information appliance and so on, usually need to be configured initially by connecting with a remote control host. The universal use for the initial or advanced configuration is to install a HTTP server program inside the network device, which the remote host can access using a web browser in a wired or wireless manner. It's not necessary to use additional software or tools because the items of the configuration can be found on a web browser. In spite of the merits mentioned above, the prior method still needs to consider complex network circumstances. The present invention relates to a method for accessing a device comprising (1) actively learning the required IP address from the broadcast information; and (2) spontaneously modifying a proper IP address with coincident network configuration and feeding back the same to a control end. Finally, the control end can access the device without any additional setting.

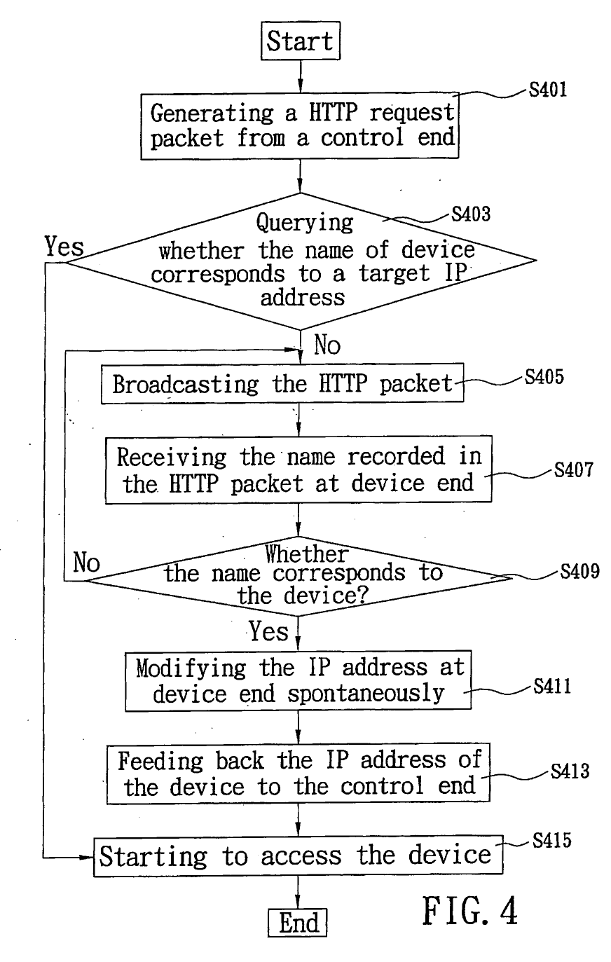

Reference is made to FIG. 4, which is a flow chart for accessing the network device of the present invention. The network device is installed with a resolution program. Then the device can actively resolve the request string about its name in a HTTP packet and further modify its network configuration accordingly from the broadcast packet.

The device's initial or modified name is requisite for the method of the present invention. The device's proprietary name, like AP001, AP002 or AP003, is included in the HTTP request packet and used to distinguish the network devices in a local area network. The method comprises the following steps. First, the network devices and the computer at the control end are connected to each other physically in a wired or wireless manner. Essentially, the network device's name (such as, for example, AP001) is prepared.

A web browser is then executed in a host of the control end, and the device's name, such as, for example, http://AP001/, is filled into the blank on the web URL. One or a more HTTP request packets is generated (step S401).

The HTTP protocol is performed to resolve the name with a domain name system (DNS), windows Internet naming service (WINS) or any other lookup table with correspondence of IP address and the name in the local area network (LAN). Then the protocol queries as to whether the name of device corresponds to a target IP address (step S403).

If step S403 can resolve the name corresponding to an IP address, step S415 afterward is performed since the IP address is fed back to the control end. If the query fails to find the correspondence of the IP and the name, step S405 is performed.

The HTTP protocol used at the control end broadcasts the HTTP request packets to the network devices and hosts in the LAN (step S405). The network devices and hosts in the LAN receive the HTTP packets with the device's name recorded therein (step S407). The embedded operation system with a resolution program in the network device resolves the name recorded in the HTTP packet, and determines whether the name corresponds to the device (step S409).

If a device in the LAN receives the packet and determines that the device's name therein does not correspond, then a packet such as NAK (Negative Acknowledge) is sent in answer to the control end. Meanwhile, the control end broadcasts the HTTP packets continuously while receiving the NAK packet. If the device receives the packet with the corresponding name, then step S411 is performed.

A resolution program is installed in the network device and is used to modify the network configuration of the network device. When the device learns the information of the packet broadcast from the control end, the IP address of the device end is modified accordingly. The spontaneous modification can prevent the conflict of IP addresses in the LAN.

Moreover, because the network device cannot retrieve the subnet mask information from the HTTP packet directly in view of the TCP/IP technology, the device broadcasts an address resolution protocol (ARP) packet by itself to confirm the mask setting with the devices or hosts nearby. After that, the resolution program will modify not only the IP address and other network configuration, but also the subnet mask (step S411).

After confirming the IP address, the device feeds back the IP address to the control end (step S413). As the control end is fed back the packet from the device-to-be-configured, the resolution of the device's name is achieved. The control starts to access the device (step S415).

In particular, the present invention discloses a method for accessing a device with an IP address being modified spontaneously. The network device can thus modify its own network configuration, learning from the HTTP packet broadcast from the control end in use when accessing.

The many features and advantages of the present invention are apparent from the written description above and it is intended by the appended claims to cover all. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A method for accessing a device with an IP address being modified spontaneously is used to access a network device using the device's name in a HTTP (Hypertext Transmission Protocol) packet, since the network device can modify a corresponding IP address learned from a control end, wherein the method comprises:
generating at least one HTTP packet;
broadcasting said HTTP packet involving said network device's name;
resolving said network device's name included in said HTTP packet, as said network device proceeds to resolution on receiving said packet;
modifying said network device's configuration learned from the information in said HTTP packet broadcast from said control end spontaneously, wherein said control end accesses said network device since the modification is in accordance with the network configuration;
feeding back said modified configuration of said network device to said control end; and
accessing said network device.

2. The method as recited in claim 1, wherein a connection between said network device and said control end is wired or wireless.

3. The method as recited in claim 1, wherein said control links said network device using a network browser.

4. The method as recited in claim 1, wherein before the step of broadcasting said HTTP packet, said HTTP packet requested in said control end resolves said network device's name using a domain name server (DNS) or Windows Internet naming service (WINS).

5. The method as recited in claim 1, wherein before the step of modifying said network device's configuration, said network device gets an IP address through address resolution protocol (ARP).
